(19) United States
(12) Patent Application Publication
(10) Pub. No.: US 2019/0381821 A1
(43) Pub. Date: Dec. 19, 2019

(54) TRANSFER FILM, USE THEREOF AND METHOD FOR PRODUCING A TRANSFER FILM AS WELL AS METHOD FOR PRODUCING AN INJECTION-MOLDED ARTICLE DECORATED WITH A TRANSFER PLY OF A TRANSFER FILM

(71) Applicant: LEONHARD KURZ Stiftung & Co. KG, Fürth (DE)

(72) Inventors: Jürgen Schmidt, Roth (DE); Wolfgang Kott, Roßtal (DE)

(21) Appl. No.: 16/479,102

(22) PCT Filed: Jan. 23, 2018
(86) PCT No.: PCT/EP2018/051574

§ 371 Date: Jul. 18, 2019

(30) Foreign Application Priority Data
Jan. 27, 2017 (DE) 10 2017 101 595.7

(51) Int. Cl. B44C 1/17; B32B 3/26; B32B 27/08; B32B 27/40; B32B 7/06; B32B 37/15; B32B 38/00; B29C 45/16

(52) U.S. Cl. CPC B44C 1/1729; B32B 2451/00; B32B 27/08; B32B 27/40; B32B 7/06; B32B 37/15; B32B 38/0008; B32B 38/145; B29C 45/1679; B32B 2255/10; B32B 2255/26; B32B 2255/28; B32B 2255/205; B32B 2305/72; B32B 2310/0831; B32B 2375/00; B32B 3/263

(57) ABSTRACT

A transfer film, in particular hot-stamping film, which includes a carrier film and a transfer ply with a top coat arranged on the carrier film and detachable from the carrier film, wherein a master structure is molded on the carrier film on its side facing the transfer ply, and wherein the top coat includes a structuring which has a structure complementary to the master structure.

The invention relates to a transfer film, the use thereof and a method for producing a transfer film. The invention furthermore relates to a method, in particular an IMD method (IMD=In-Mold Decoration), for producing an injection-molded article decorated with a transfer ply of a transfer film.

Composite molded parts composed of a film and a plastic molded body have been known for a long time. Composite molded parts with a surface with tactile or haptically perceptible properties, in particular with a soft-touch coating, are becoming increasingly important. Depending on the coating, it has a velvety, rubbery or also soft surface. Such molded parts are becoming increasingly important in communication devices as well as in vehicle, ship and aircraft construction.

As a rule, composite elements are produced from a soft-touch layer and the plastic component by means of subsequent coating of the component. Here, a varnish with pigments, fillers etc. Is applied wet directly over the whole surface. The small particles of the pigments, fillers etc. then produce an optical modification on the dry surface and contribute via a modified friction to the tactile soft-touch effect when stroked or touched. An example of an optical modification would be a matting, combined with an increased friction when stroked or touched.

This subsequent application, in particular over the whole surface, of the soft-touch layer has some disadvantages. For one thing, it entails a large number of work steps some of which must be carried out manually. Furthermore, the reject rate is relatively high. In addition, this method requires a very high layer thickness, which involves high costs and high material consumption. Moreover, the particles projecting out of the surface mean that the surface is easily scratched. A further important restriction of this known procedure is that, by depositing over the whole surface, the generation of patterns or motifs, i.e. a partial soft-touch layer, is not possible.

Thus the object of the present invention is to provide a transfer film, in particular with a soft-touch effect, which can be used in a wide range of applications, in particular also in the field of IMD, without a deterioration in the surface feel properties.

The object is achieved with a transfer film, in particular hot-stamping film, which comprises a carrier film and a transfer ply with a top coat arranged on the carrier film and detachable from the carrier film, wherein a master structure is molded on the carrier film on its side facing the transfer ply, and wherein the top coat comprises a structuring which has a structure complementary to the master structure.

The object is further achieved with a method for producing a transfer film, in particular for use as IMD soft-touch film, which comprises a carrier film and a transfer ply with a top coat arranged on the carrier film and detachable from the carrier film, wherein a master structure, in particular master relief structure, is incorporated or produced in the carrier film, and wherein the top coat is applied to the master structure, wherein a structure complementary to the master structure of the carrier film is molded into the top coat.

The object is further achieved with a method, in particular an IMD method, for producing an injection-molded article decorated with a transfer ply of a transfer film, with the following steps:
arranging a transfer film according to the invention in an injection mold,
back injection molding the transfer film with a plastic injection-molding composition,
removing the carrier film together with the master structure from the transfer ply of the transfer film.

The invention makes it possible to obtain a transfer film or a transfer ply of a transfer film with a soft-touch effect, wherein the pattern of the film can be freely chosen, i.e. there is no restriction to one color, as is the case when spray-coating over the whole surface. Furthermore, areas with different optical properties, in particular in respect of reflection, absorption, refractive index, for example matte-gloss effects, are possible and the individual effects can be adapted accordingly to the respective intended use. In addition, the film can be used well in the IMD method.

This is achieved in the present case in particular through the structuring of the surface of the top coat by means of the master structure. The functional properties of the top coat can hereby be controlled, as a result of which in particular the tactile feel of the surface, in particular the grip, the fingerprint sensitivity, dirt-repellent and/or liquid-repellent functions and/or the level of matting can be controlled. The structure incorporated into the top coat in particular provides the soft-touch effect of the transfer film, in particular the soft-touch effect of the transfer ply of the transfer film.

According to the invention, by soft-touch effect is meant in particular an effect which produces a pleasant, velvety touch—similar to the skin of a peach. The varnishes used for the top coat have in particular a soft grip on their surface. Overall, varnishes with a soft-touch effect on their surface have in particular a haptically perceptible effect.

The invention furthermore makes it possible for the top coat to have a structuring without it having to contain pigments, in particular particles and/or solid particles. This is achieved in particular in that the master structure is molded merely into the top coat. This means in particular that the master structure forms a negative mold and leaves corresponding indentations in the top coat. Overall, the tactile properties, in particular the fact that the friction is increased, as well as the optical properties, can be improved through the film according to the invention. Furthermore, the fingerprint sensitivity is also reduced.

The top coat is preferably formed such that it has a soft-touch effect. Ideally, the top coat is formed as soft-touch varnish.

Advantageously, a structured varnish comprises the master structure. For this, the structured varnish preferably comprises a raised structure or surface.

The carrier film can consist of a structured varnish, in particular of a self-supporting structured varnish. If a self-supporting structured varnish is involved, the latter is then preferably made of silicone. The structured varnish advantageously has a Shore A hardness of from 10 to 50.

The thickness of the self-supporting structured varnish is preferably between 10 μm and 5000 μm, in particular between 10 μm and 500 μm, in particular preferably between 10 μm and 250 μm. Advantageously, the master structure is incorporated to into the structured varnish by means of stamping. For example, the self-supporting structured varnish can be a directly structured self-supporting film into which a structure will be or is incorporated into the film material preferably by means of stamping/replication and/or etching and/or engraving and/or laser structuring. The carrier film preferably comprises a carrier layer and a structured varnish arranged on the carrier layer in the direction of the transfer ply. The carrier layer is preferably formed from ABS, ABS/PC, PET, PC, PMMA, PE and/or PPP. The layer thickness of the carrier layer is advantageously between 5 μm and 500 μm, in particular between 6 μm and 100 μm.

The structured varnish is preferably arranged over the whole surface of the carrier layer. This means that the structured varnish extends over the whole carrier layer. However, it is also possible for the structured varnish to be arranged only partially, i.e. in areas, on the carrier layer. The structured varnish is preferably arranged in the pattern on the carrier layer. Because the structured varnish is arranged only in areas on the carrier layer, a matte-gloss effect can be realized overall. In addition to the different optical properties, the different matte and/or glossy areas are characterized in particular with respect to reflection, absorption and/or refractive index, in particular by different friction and different tactile properties.

Here, an optical difference can be perceived by the naked human eye between a matte and a less matte, in particular glossy or also more glossy area, in particular above an optically perceptible gloss difference of 2, measured at 60° measuring angle with the micro-gloss meter from Byk-Gardener.

If the structured varnish is arranged in the pattern or in areas on the carrier layer, then preferably areas form which have a matte effect, namely in particular areas in which the structured varnish is located, and areas which remain glossy. The glossy areas can be the surface of the carrier layer. However, it is also possible to apply a further varnish layer to the carrier layer, in particular a smooth varnish, in areas where no structured varnish is present.

The master structure or the structured varnish and/or the top coat preferably have a homogeneous surface structure at least in areas. Within the meaning of the invention, by homogeneous surface structure is meant in particular a structure which is formed such that the surface appears uniform, preferably in one area of surface. In that area of surface, no optical surface defects are then visible.

The structured varnish is preferably formed from melamine, polyurethane (PU), polyacrylates, polyol, isocyanate and/or polyvinyl chloride. Advantageously, the structured varnish has a layer thickness of from 0.1 μm to 10 μm, preferably from 0.5 μm to 7 μm.

Advantageously, the master structure or the structured varnish has a structural depth of from 1 μm to 10 μm, preferably between 2 μm and 4 μm, in particular between 3 μm and 4 μm. A particularly good soft-touch effect of the top coat can be achieved as a result of such a structural depth.

However, it is also possible for the structural depths to be larger. This is preferably achieved in that the master structure or the structured varnish has larger particles. Through the selection of particles of corresponding size, the structural depth of the master structure or of the structured varnish can be optimally adapted to the respective use. Ideally, the master structure or the structured varnish comprises fillers with a particle size of approximately 6 μm, preferably 8 μm. In principle, particles with a size of 15 μm can also be used. Possible fillers can be silicone beads, mineral fillers (e.g. corundum or milled river gravel), inorganic fillers (e.g. SiO₂) and/or also polyurethane particles.

Advantageously, the master structure or the structured varnish comprises structure-giving particles. Preferably, approximately 50% to 80% of the structure-giving particles are between 2 μm and 4 μm in size. The remaining particles, in particular the remaining 20% to 50%, are formed from larger particles. The size of the larger particles can be for example 6 μm to 15 μm.

In principle, the particles are not restricted to any fixed shape. The particles can be formed both as in particular angular broken material and spherical. Ideally, the particles located in the master structure or structured varnish can be formed to differently. It is advantageous for the shape of the particles to be adapted to the respective requirements.

It is advantageous for the master structure or the structured varnish to have a chemically inert surface. Within the meaning of the invention, inert surface is to be understood in particular to mean that under the respective prevailing conditions the surface does not react or reacts only to an extremely small extent with potential reactants such as for example air, water, the top coat. It can hereby be ensured that there is no bonding or joining between top coat and master structure, and thus a separation of top coat and master structure is possible.

The structured varnish preferably comprises at least one UV-curable and/or at least one isocyanate component and/or at least one melamine component.

Advantageously, the top coat is formed from long-chain polymers. The polymers can be formed cross-linked. The cross-linking is preferably based on UV curing and/or on chemical reactions.

The top coat is preferably formed from polyol, polyurethane (PU), copolymers of PU and polyol and/or copolymers of polyurethane (PU) and polyacrylates. Ideally, the top coat is formed from polyurethane (PU), in particular with a molecular weight between 2000 and 8000. The polyurethanes (PU) are preferably formulated into a soft-touch varnish via a cobinder, for example via polyols and/or via melamine resins, or with an isocyanate binder.

The layer thickness of the top coat is advantageously between 0.5 μm and 100 μm, in particular between 0.2 μm [ . . . ] 50 μm, particularly preferably between 5 μm and 30 μm.

The top coat, in particular the binder matrix of the top coat, can comprise fillers, preferably spherical fillers made of PMMA, silicones, polyurethanes, different copolymers and/or mineral compounds. Furthermore, the top coat, in particular the binder matrix of the top coat, can comprise silicone-containing acrylates, silicone-containing polyurethanes, oils, waxes and/or wax dispersions. Through the use of such additives or fillers, the elasticity of the top coat and/or the tactile or haptic properties associated with it, as the so-called “feel”, can be strengthened.

The top coat advantageously comprises silicones. Through the use of silicones, the scratch resistance, the grip as well as the surface quality of the top coat can be improved. In addition, the detachment properties between top coat and structured varnish can be controlled through the use of silicone.

The top coat preferably comprises UV-curable components. Advantageously, the UV-curable components can be used as secondary binder or main binder.

The top coat can have a gloss level of between 20 and 60, preferably between 30 and 50. These relatively high gloss levels are preferably measured at a measuring angle of 85° with the micro-gloss meter from Byk-Gardener.

In order to achieve a further matting of the top coat, the top coat can comprise a matting agent. Possible matting agents can be silicone beads, mineral fillers (e.g. corundum or milled river gravel), inorganic fillers (e.g. SiO₂), polytetrafluoroethylene (PTFE, Teflon®) or also polyurethane particles.

Ideally, the top coat has an elongation of at least 50%, preferably of at least 100%, in particular preferably of at least 200%. This makes a deformable top coat possible. As a result of such an elongation behavior of the top coat, the transfer film is particularly suitable for use in IMD methods. During the deformation in the IMD method, the carrier film absorbs most of the tensile forces. As a result of the elongation properties of the top coat, it is ensured, in particular when in contact with the contour of the injection-molding tool, that the top coat suffers no damage in particular as a result of tearing or micro-cracks. The elongation values were ascertained in a standardized tensile test (DIN 53504, ISO 37) with the Zwick Z005 test apparatus from Zwick GmbH & Co. KG, Ulm.

It is advantageous if the top coat has a temperature resistance of up to 200° C. It can hereby be ensured that the top coat withstands the thermal stresses through the injection-molded material, in particular in the IMD method, and in particular no modification is effected in the structuring or the surface of the top coat.

The top coat or the surface of the top coat is preferably formed such that it can be resistant to solvents such as for example isopropanol and MEK, to weathering such as for example sunlight, rain and/or dew, to foodstuffs such as for example coffee, to cleaning agents and/or to mechanical stresses as well as to high thermal stresses.

The top coat can have for example a pencil hardness HB (HB=hard black=medium hard). The pencil hardness is measured in particular according to ASTM 3363 with the SH3000 pencil hardness tester from mtv Messtechnik, Erftstadt, Germany. Pencils with graduated hardness grades are moved over the surface to be tested at a defined angle and pressure. In particular for ASTM D 3363, the test is begun with the hardest pencil and continued downwards in the hardness scale, in order to determine which next-softest pencil does not damage (no longer damages) the coating and which next-softest pencil produces no (more) scratches in the coating. Through the combination of surface structure and softness of the top coat, the tactile properties of the top coat are further improved. Moreover, a strong matting effect is produced. Overall, a marked soft-touch effect can thus be achieved.

It is conceivable that the top coat has a lower hardness than the master structure, than the structured varnish and/or than known protective coatings of IMD films.

It is advantageous if a detachment layer is arranged between the top coat and the master structure. This ensures that a reliable detachment of the transfer ply from the carrier film can be guaranteed. Furthermore, too strong an adhesion between the top coat and the master structure or the structured varnish can be prevented in that the master structure or the structured varnish comprises corresponding additives such as silicones, aliphatic hydrocarbons etc. However, it is also possible for the top coat to comprise corresponding additives such as for example silicones, aliphatic hydrocarbons etc.

In order to be able to process the transfer film well, in particular in standard decoration methods such as for example vertical stamping, rolling on or also the IMD method, the adhesion strength between top coat and master structure or the structured varnish is preferably between 3 N/m and 40 N/m, in particular preferably between 10 N/m and 30 N/m. As a result, an easy and reliable detachment of the transfer ply can be guaranteed overall. For this, the transfer ply with a width of 35 mm and a length of 150 mm is in particular stamped on an ABS plate at 180° C. and a rate of 13 m/min. The detachment strength measurement preferably takes place on a Zwick/Roell Z 1.0 tensile testing machine at room temperature (20° C.). For this, the transfer ply is removed from the ABS plate in particular at an angle of 90° and a measured displacement of 150 mm, wherein the detachment strength is determined.

The detachment layer preferably has a layer thickness of from 0.001 μm to 2 μm, in particular from 0.05 μm to 1 μm. The detachment layer can consist of a wax or comprise a wax. This can be e.g. a carnauba wax, a montanic acid ester, a polyethylene wax, a polyamide wax or a PTFE wax. In addition, however, surface-active substances such as silicones are also suitable as detachment layer. Thin layers made of melamine-formaldehyde resin-cross-linked varnishes can also serve as detachment layer.

Advantageously, an intermediary layer, in particular an adhesion-promoting layer or an adhesion promoter, is arranged on the side of the top coat facing away from the carrier film. The intermediary layer ensures in particular that a very good adhesion is produced between the top coat and the other layers of the transfer ply. Moreover, the intermediary layer serves in particular as a barrier layer. It prevents substances penetrating from outside into the top coat from being able to penetrate into the other layers of the transfer ply.

The intermediary layer preferably comprises cross-linkable acrylates, in particular polyacrylates, polyester resins, alkyd resins as well as their modifications, amino resins, amido resins or phenolic resins. Isocyanate can be used as cross-linking component. In principle, all current cross-linkings are conceivable here. A UV cross-linking as well as a dual cure system, i.e. In particular a cross-linking based on external radiation energy and in addition based on chemical reactions can be used.

Ideally, the intermediary layer has a layer thickness between 0.1 μm and 10 μm, preferably between 0.5 μm and 5 μm, particularly preferably between 0.3 μm and 4 μm.

Furthermore, the transfer film, in particular the transfer ply, can comprise a decorative layer, in particular at least one color layer and/or at least one metallization and/or at least one adhesive layer or a primer layer. The layers can be applied here over the whole surface as well as only partially or in areas.

The decorative layer can comprise one or more partial or full-surface color layers to generate a pattern and/or a motif. In particular, the color layers can also be in register with the partial areas of the soft-touch varnish with their different optical properties, in particular with respect to reflection, absorption and/or refractive index. The layer thickness of the decorative layer is preferably 0.1 μm to 10 μm, in particular 0.5 μm to 5 μm.

By register or registration, or register accuracy or registration accuracy, is meant a positional accuracy of two or more elements and/or layers relative to each other. The register accuracy is to range within a predetermined tolerance and be as low as possible. At the same time, the register accuracy of several elements and/or layers relative to each other is an important feature in order to increase the process stability. The positionally accurate positioning can be effected in particular by means of sensory, preferably optically detectable registration marks or register marks. These registration marks or register marks can either represent special separate elements or areas or layers or themselves be part of the elements or areas or layers to be positioned.

The decorative layer can comprise a replication layer into which diffractively and/or refractively acting micro- or macrostructures are molded. This replication layer is preferably provided with a reflective layer which can consist of a metallization and/or an HRI layer with a high refractive index (HRI=High Refractive Index). Here, the s reflective layer can be opaque, semi-transparent or transparent.

One or more of the following structures can be molded in the replication layer: a diffractive structure, a zero-order diffraction structure, a blazed grating, a macrostructure, in particular a lens structure or microprism structure, a mirror surface, a matte structure, in particular an anisotropic or isotropic matte structure.

The structures in the replication layer can represent a pattern and/or a motif which can also be arranged in particular in register with the color layers of the decorative layer and/or in register with the partial areas of the soft-touch varnish.

The metallization is preferably produced by means of vapor deposition. Cr, Sn and/or Al are suitable in particular as metal. Through the use of a layer made of metal, a soft-touch film with metallic appearance is obtained. The vapor-deposited metallization can be effected over the whole surface and either retained over the whole surface or else structured with known demetallization methods such as etching, lift-off or photolithography and thus be only partially present. However, the metallization can also consist of a printed layer made of metallic pigments in a binder. These printed metallic pigments can be applied over the whole surface or partially and have different colorings in different surface areas. The metallization can represent a pattern and/or a motif which can also be arranged in particular in register with the color layers of the decorative layer and/or with the structures of the replication layer and/or in register with the partial areas of the soft-touch varnish.

The adhesive layer or the primer layer ensures in particular that there is a good adhesion between the transfer film or between the transfer ply of the transfer film and a plastic injection-molding composition or a plastic body.

The adhesive layer or the primer layer preferably has a layer thickness of from 0.1 μm to 10 μm, in particular from 0.1 μm to 3 μm, and can also comprise several partial layers.

Advantageously, a haptic varnish is arranged at least in areas on the side of the carrier layer facing away from the top coat or on the side of the structured varnish facing away from the top coat. By haptic varnish within the meaning of the invention is meant in particular a varnish which results in a spatial deep structuring or deformation of the film. For this purpose, the haptic varnish is substantially dimensionally stable. As a result of the external effect of force, the haptic varnish pushes into the softer, deformable carrier layer and/or the softer, deformable structured varnish, as a result of which it molds its negative shape. If a film with such a haptic varnish is processed further, for example in an IMD method or during hot stamping, then the haptic varnish does not deform or deforms only negligibly. The use of a transfer film with haptic varnish for an IMD method or for hot pressing makes it possible to form spatial deep structures on the transfer ply on an injection-molded article decorated with such a transfer ply. As a result, in addition to the soft-touch effect, a likewise haptically perceptible or tactile and also optically perceptible relief structure can be produced partially or over the whole surface. Here, the haptic varnish can also be arranged in particular in register with the partial areas of the soft-touch varnish and/or with the color layers of the decorative layer and/or with the structures of the replication layer and/or in register with the partial areas of the metallization.

The haptic varnish preferably has a layer thickness between 1 μm and 500 μm. In particular between 5 μm and 100 μm.

The layer thickness of the haptic varnish is decisive for the producible depth of the spatial structuring. In order to achieve a haptically detectable, spatial structuring, a haptic varnish in particular at least 5 μm, preferably at least 10 μm thick is necessary which cannot be deformed or can be deformed only to a small extent under the processing conditions for the transfer film. The thickness of the haptic varnish on a carrier film can be formed differently here, with the result that spatial structures of different depths can be produced at the same time.

It has proved particularly worthwhile for the haptic varnish to comprise a thermosetting plastic or a thermoplastic with a glass transition temperature Tg above 200° C. However, the use of a haptic varnish made of a non-cross-linking varnish system filled with a filer, wherein the filler is preferably formed from inorganic fillers such as for example titanium dioxide, has also proved worthwhile. Such haptic varnishes are dimensionally stable and pressure-resistant up to high temperatures, with the result that there is no deformation of the structured layer under injection conditions or only to an extremely small extent.

Furthermore, it has proved particularly worthwhile for the haptic varnish to be a radiation-curable, for example UV-curable, or an electron-beam-curable or an epoxy-curable or an isocyanate-curable or acid-curable varnish. Such cross-linking varnishes have the required dimensional and pressure stability at high processing temperatures and can be easily processed even with a high solids content.

It is particularly preferred here if the haptic varnish has a solids content of at least 40%, preferably 100%. The high solids content increases the achievable layer thickness of the haptic varnish and improves the transcription capacity of the haptic varnish. Thus the achievable depth of the spatial structures is increased.

It has proved advantageous if the haptic varnish is colored differently to the carrier film or carrier layer. This enables a visual examination of the haptic varnish, for example with respect to its completeness, as well as a simpler and more accurate, also automatic, positioning of the transfer film in the selected processing method.

It is advantageous if the master relief structure is produced by applying the structured varnish to the carrier layer. The application of the structured varnish to the carrier layer is preferably effected in an additional process step. The structured varnish can be printed on, in particular in a resolution of up to 150 μm. The structured varnish can be applied to the carrier layer over the whole surface as well as partially or in the pattern. In principle, it is also conceivable for the structured varnish to be applied over the whole surface of the carrier layer in a first step and removed again in areas by means of etching in a further step.

If the structured varnish is arranged only in areas on the carrier layer, it is then advantageous if a further varnish, in particular a varnish with a non-raised surface, preferably with a smooth and/or glossy surface, is applied at least in areas to the carrier layer in areas where no structured varnish is arranged.

Advantageously, a slightly matted structured varnish is applied, in particular printed on, to a glossy carrier layer. However, it is also possible for an even more strongly matted structured varnish to be applied to an already slightly matted carrier layer. As a result, an optical effect is achieved, in particular above an optically perceptible gloss difference of 2, measured at 60° measuring angle with the micro-gloss meter from Byk-Gardener. The gloss effect can advantageously be modified according to aspects of the design and/or functionality and/or can be freely chosen.

In order to improve the adhesion between carrier layer and structured varnish, the carrier layer can be pre-treated. This ensures that the structured varnish, together with the carrier layer, in particular after an IMD process, can be 100% securely removed again from the transferred transfer ply. This can be achieved in particular through the pre-treatment of the carrier layer. Methods such as corona treatment, UV-light irradiation as well as flame treatment are suitable for this.

It is advantageous if the top coat is cured by means of UV curing or thermally during the production of the transfer film.

The further layers of the transfer ply, in particular the intermediary layer or the adhesion promoter, the decorative layer, preferably the color layer, and/or the adhesive layer or the primer layer, are advantageously applied to the top coat by means of printing. The application of the metallization is effected in particular by means of vapor deposition.

If the transfer film according to the invention is used in a method, in particular in an IMD method, for producing an injection-molded article decorated with the transfer ply of the transfer film, it is then advantageous if the top coat is already cured during the production of the transfer film, in particular by means of UV curing and/or thermally.

However, it is also possible for the curing of the top coat as post-cure film to be carried out. By curing the top coat as post-cure film is meant within the meaning of the invention in particular a UV curing after the processing, in particular the deformation on an injection-molded article.

The use of the transfer film as soft-touch film has proved ideal. Furthermore, the use of the transfer film according to the invention as IMD film has proved excellent. The use of the transfer film according to the invention for producing an injection-molded article decorated with the transfer ply, which has a soft-touch effect in the area of the transfer ply, is also ideal. The transfer film with the finished soft-touch coating or soft-touch surface is introduced into an injection-molding tool and then back injection molded.

Injection-molded articles decorated in such a way are preferably used as decorative components for motor vehicles, for ships, for airplanes or also in telecommunications devices or household appliances.

In the following the invention is explained with reference to several embodiment examples utilizing the attached drawings by way of example. There are shown in:

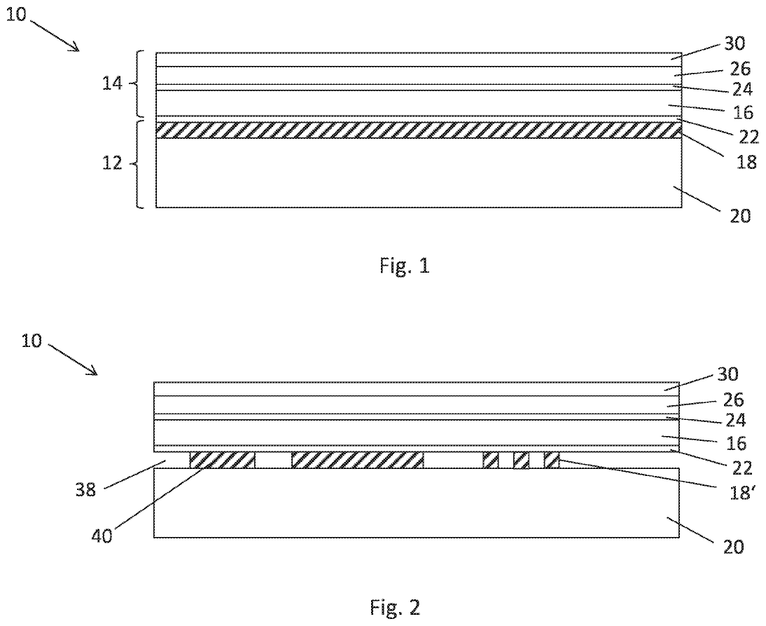

FIG. 1 a schematic sectional representation of a transfer film.

FIG. 2 a schematic sectional representation of a further transfer film.

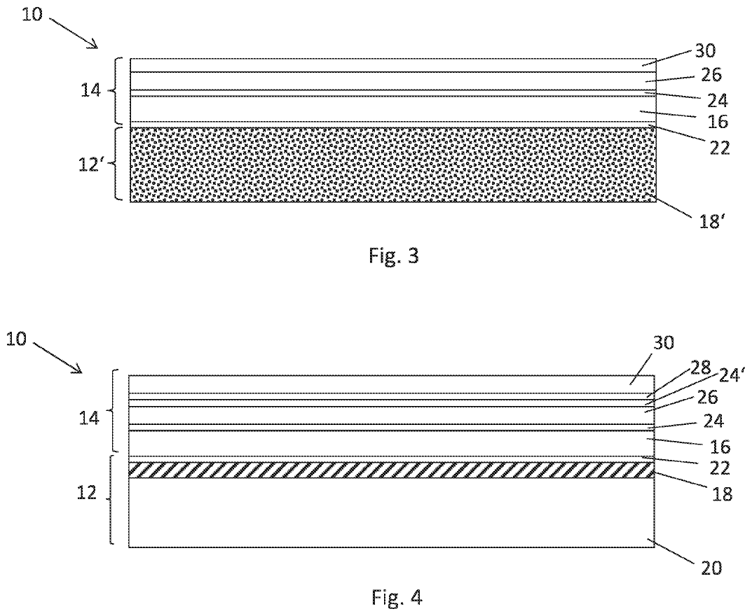

FIG. 3 a schematic sectional representation of a further transfer film.

FIG. 4 a schematic sectional representation of a further transfer film.

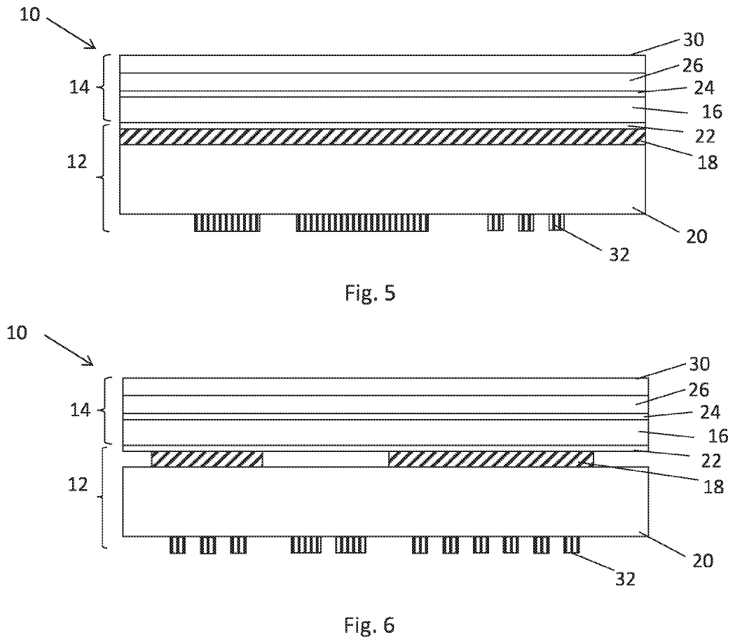

FIG. 5 a schematic sectional representation of a further transfer film.

FIG. 6 a schematic sectional representation of a further transfer film.

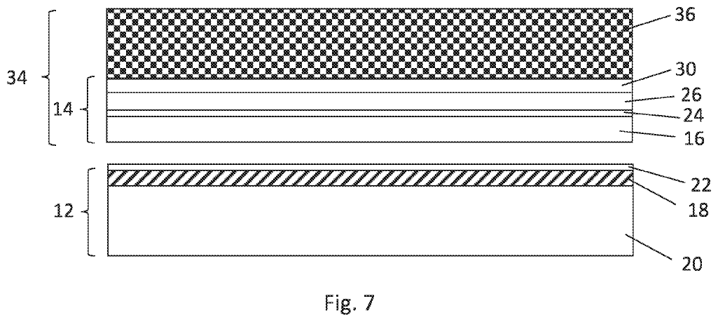

FIG. 7 a schematic sectional representation of an injection-molded article decorated with a transfer ply.

FIG. 1 shows a schematic sectional representation of a transfer film 10. The transfer film 10, in particular hot-stamping film, comprises a carrier film 12 and a transfer ply 14 arranged on the carrier film 12 and detachable from the carrier film 12. The transfer ply 14 comprises a top coat 16. A master structure is molded on the carrier film 12 on its side facing the transfer ply 14, wherein the top coat 16 comprises a structuring which has a structure complementary to the master structure. It is advantageous if a structured varnish 18 comprises the master structure.

The structure incorporated into the top coat 16 provides in particular the soft-touch effect of the transfer film 10. Depending on the structuring of the surface of the top coat 16 by means of the master structure, the functional properties of the top coat 16 can be controlled, as a result of which in particular the tactile or hapticaily perceptible properties of the surface, the fingerprint sensitivity, dirt-repellent and/or liquid-repellent functions and/or the level of matting can be controlled.

The carrier film 12 shown in FIG. 1 preferably comprises a carrier layer 20 and the structured varnish 18 arranged on the carrier layer 20 in the direction of the transfer ply 14. The carrier layer 20 is preferably formed from ABS, ABS/PC, PET, PC, PMMA, PE and/or PPP. The layer thickness of the carrier layer 20 is advantageously between 5 μm and 500 μm, in particular between 6 μm and 100 μm.

The structured varnish 18 is arranged over the whole surface of the carrier layer 20 in FIG. 1. Advantageously, the structured varnish 18 is formed from melamine, polyurethane (PU), polyacrylates, polyol, isocyanate and/or polyvinyl chloride.

Ideally, the structured varnish 18 has a layer thickness of from 0.1 μm to 10 μm, in particular from 0.5 μm to 7 μm. It is advantageous if the structured varnish 18 has a structural depth between 1 μm and 10 μm, preferably between 2 μm and 4 μm, in particular between 3 μm and 4 μm. A particularly good soft-touch effect of the top coat 16 can be achieved as a result of such a structural depth. However, it is also possible for the structural depths to be larger. This is preferably achieved in that the master structure or the structured varnish 18 has larger particles. Through the selection of particles of corresponding size, the structural depth of the master structure or of the structured varnish 18 can be optimally adapted to the respective use. Ideally, the master structure or the structured varnish 18 comprises fillers with a particle size of approximately 6 μm, preferably 8 μm. In principle, particles with a size of 15 μm can also be used.

Advantageously, the top coat 16 is formed from long-chain polymers. The polymers can be formed cross-linked. The cross-linking is preferably based on UV curing and/or on chemical reactions. The top coat 16 is particularly preferably formed from polyol, polyurethane (PU), copolymers of polyurethane (PU) and polyol and/or to copolymers of polyurethane (PU) and polyacrylates. Ideally, the top coat 16 is formed from polyurethane (PU), in particular with a molecular weight between 2000 and 8000. The polyurethanes are preferably formulated into a soft-touch varnish via a cobinder, for example via polyols and/or via melamine resins, or with an isocyanate binder.

The layer thickness of the top coat 16 is advantageously between 0.5 μm and 100 μm, in particular between 0.2 μm [ . . . ] 50 μm, particularly preferably between 5 μm and 30 μm.

The top coat 16, in particular the binder matrix of the top coat 16, can comprise fillers, preferably spherical fillers made of PMMA, silicones, polyurethanes (PU), different copolymers and/or mineral compounds. Furthermore, the top coat 16, in particular the binder matrix of the top coat 16, can comprise silicone-containing acrylates, silicone-containing polyurethanes, oils, waxes and/or wax dispersions. Through the use of such additives or fillers, the elasticity of the top coat 16 and the tactile or haptic properties associated with it, as the so-called “feel”, can be strengthened.

The top coat 16 advantageously comprises silicones. Through the use of silicones, the scratch resistance, the grip as well as the surface quality of the top coat 16 can be improved. In addition, the detachment properties between top coat 16 and structured varnish 18 can be controlled through the use of silicone.

Ideally, the top coat 16 has an elongation of at least 50%, preferably of at least 100%, in particular preferably of at least 200%. This makes a deformable top coat 16 possible. As a result of such an elongation behavior of the top coat 16, the transfer film 10 is particularly suitable for use in the IMD method.

A detachment layer 22 is preferably arranged between the top coat 16 and the structured varnish 18. The detachment layer 22 ensures a reliable detachment of the transfer ply 14 from the carrier film 12 by preventing too strong an adhesion between the top coat 16 and the structured varnish 18. Instead of or in addition to a detachment layer 22, it is advantageous if the structured varnish 18 and/or the top coat 16 comprise additives such as for example silicones, aliphatic hydrocarbons etc., which reduce the adhesion between top coat 16 and structured varnish 18.

The detachment layer 22 preferably has a layer thickness of from 0.001 μm to 2 μm, in particular from 0.05 μm to 1 μm. The detachment layer 22 can consist of a wax or comprise a wax. This can be e.g. a camauba wax, a montanic acid ester, a polyethylene wax, a polyamide wax or a PTFE wax. In addition, however, surface-active substances such as silicones are also suitable as detachment layer 22. Thin layers made of melamine-formaldehyde resin-cross-linked varnishes can also serve as detachment layer 22.

Advantageously, an intermediary layer 24, in particular an adhesion promoter, is arranged on the side of the top coat 16 facing away from the carrier film 12. The intermediary layer 24 ensures in particular that a very good adhesion is produced between the top coat 16 and the other layers of the transfer ply 14. Moreover, the intermediary layer 24 advantageously serves as a barrier layer. In particular, it prevents substances penetrating from outside into the top coat 16 from being able to penetrate into the other layers of the transfer ply 14.

The intermediary layer 24 preferably comprises cross-linkable acrylates, in particular polyacrylates, polyester resins, alkyd resins as well as their modifications, amino resins, amido resins or phenolic resins. Isocyanate can be used as cross-linking component. In principle, all current cross-linkings are conceivable here. A UV cross-linking as well as a dual cure system, i.e. in particular a cross-linking based on external radiation energy and in addition based on chemical reactions can be used.

Ideally, the intermediary layer 24 has a layer thickness between 0.1 μm and 10 μm, preferably between 0.5 μm and 5 μm, particularly preferably between 0.3 μm and 4 μm.

Furthermore, the transfer film 10, in particular the transfer ply 14, preferably has a decorative layer 26. The decorative layer 26 is in particular a color layer. The layer thickness of the decorative layer 26 is preferably 0.1 μm to 10 μm, in particular 0.5 μm to 5 μm. The decorative layer 26 is formed over the whole surface. However, it is also conceivable that the decorative layer 26 is applied only partially or in areas.

The decorative layer 26 can comprise one or more partial or full-surface color layers to generate a pattern and/or a motif, which [have] also in particular in register with the partial areas of the soft-touch varnish with their different optical properties, in particular with respect to reflection, absorption and/or refractive index. The layer thickness of the decorative layer 26 is preferably 0.1 μm to 10 μm, in particular 0.5 μm to 5 μm.

The decorative layer 26 can comprise a replication layer into which diffractively and/or refractively acting micro- or macrostructures are molded. This replication layer is preferably provided with a reflective layer which can consist of a metallization 28 and/or an HRI layer with a high refractive index (HRI=High Refractive Index). Here, the reflective layer can be opaque, semi-transparent or transparent.

One or more of the following structures can be molded in the replication layer: a diffractive structure, a zero-order diffraction structure, a blazed grating, a macrostructure, in particular a lens structure or microprism structure, a mirror surface, a matte structure, in particular an anisotropic or isotropic matte structure.

The structures in the replication layer can represent a pattern and/or a motif which can also be arranged in particular in register with the color layers of the decorative layer 26 and/or in register with the partial areas of the soft-touch varnish.

The metallization 28 is preferably produced by means of vapor deposition. Cr, Sn and/or Al are suitable in particular as metal. Through the use of a layer made of metal, a soft-touch film with metallic appearance is obtained. The vapor-deposited metallization 28 can be effected over the whole surface and either retained over the whole surface or else structured with known demetallization methods such as etching, lift-off or photolithography and thus be only partially present. The metallization 28 can also consist of a printed layer made of metallic pigments in a binder. These printed metallic pigments can be applied over the whole surface or to partially and have different colorings in different surface areas. The metallization 28 can represent a pattern and/or a motif which can also be arranged in particular in register with the color layers of the decorative layer 26 and/or with the structures of the replication layer and/or in register with the partial areas of the soft-touch varnish.

In addition, the transfer film 10, in particular the transfer ply 14, preferably has an adhesive layer 30 or a primer layer. The adhesive layer 30 or the primer layer ensures in particular that there is a good adhesion between the transfer film 10 or between the transfer ply 14 of the transfer film 10 and a plastic injection-molding composition 36 or a plastic body. The adhesive layer 30 can be applied here over the whole surface as well as only partially or in areas. The adhesive layer 30 or the primer layer preferably has a layer thickness of from 0.1 μm to 10 μm, in particular from 0.1 μm to 3 μm.

FIG. 2 shows a schematic sectional representation of a further transfer film 10. The structured varnish 18′ is arranged partially, i.e. in areas, on the carrier layer 20 in FIG. 2. Ideally, the structured varnish 18′ is arranged in the pattern on the carrier layer 20. Because the structured varnish 18′ is arranged only in areas on the carrier layer 20, in particular surface areas with different levels of gloss or different mattings can be realized. In addition to the different optical properties, the different surface areas are characterized in particular with respect to reflection, absorption and/or refractive index, in particular by different friction and different tactile properties.

If the structured varnish 18′ is arranged in the pattern or in areas on the carrier layer 20, then preferably areas 40 are present which have a matte effect, namely in particular areas in which the structured varnish 18′ is located, and areas 38 are present which remain glossy. The glossy areas 38 can be the surface of the carrier layer 20. However, it is also possible to apply a further varnish layer, in particular a smooth varnish, to the carrier layer 20 in areas where no structured varnish 18′ is present.

FIG. 3 shows a schematic sectional representation of a further transfer film 10. The carrier film 12′ shown in FIG. 3 consists of the structured varnish 18′. Here, preferably a self-supporting structured varnish 18′ is involved. The structured varnish 18′ is preferably formed from silicone. The structured varnish 18′ advantageously has a Shore A hardness of from 10 to 50.

The thickness of the self-supporting structured varnish 18′ is preferably between 10 μm and 5000 μm, in particular between 10 μm and 500 μm, in particular preferably between 10 μm and 250 μm. Advantageously, the master structure is incorporated into the structured varnish 18′ by means of stamping.

The transfer ply 14 shown in FIG. 3 corresponds substantially to the transfer ply 14 shown in FIG. 1.

FIG. 4 shows a schematic sectional representation of a further transfer film 10. The transfer ply 14 of the transfer film 10 has a metallization 28. The metallization 28 is preferably produced by means of vapor deposition. Cr. Sn and/or Al are suitable in particular as metal. Through the use of a layer made of metal, in particular a soft-touch film with metallic appearance is obtained. The metallization 28 is formed over the whole surface in FIG. 4. However, it is also possible for the metallization 28 to be arranged only in areas, in particular in the pattern.

In order to obtain a good adhesion between the metallization 28 and the decorative layer 26, an adhesion promoter 24′ is arranged between these layers.

The carrier film 12 represented in FIG. 4 corresponds substantially to the carrier film 12 represented in FIG. 1. It comprises a carrier layer 20 and a structured varnish 18 arranged over the whole surface thereof. However, the structured varnish 18 can also be arranged only in the pattern on the carrier layer 20.

FIGS. 5 and 6 each show a schematic sectional representation of a further transfer film 10, wherein a haptic varnish 32 is arranged at least in areas on the side of the carrier layer 20 facing away from the top coat 16. Haptic varnish 32 is substantially dimensionally stable. If a film with a haptic varnish 32 is processed further, for example in an IMD method or during hot stamping, then the haptic varnish 32 does not deform or deforms only negligibly. The use of a transfer film 10 with haptic varnish 32 for IMD or hot pressing makes it possible to form spatial structures in the area of the transfer ply 14 on a plastic article 34 decorated with same.

The haptic varnish 32 preferably has a layer thickness between 1 μm and 500 μm, in particular between 5 μm and 100 μm. In order to achieve a haptically detectable, spatial structuring, a haptic varnish 32 in particular at least 5 μm, preferably at least 10 μm thick is necessary which cannot be deformed or can be deformed only to a small extent under the processing conditions for the transfer film 10.

The transfer ply 14 represented in FIG. 5 corresponds substantially to the transfer ply 14 represented in FIG. 1. The transfer ply 14 represented in FIG. 6 corresponds substantially to the transfer ply 14 represented in FIG. 2.

FIG. 7 shows a schematic sectional representation of an injection-molded article 34 decorated with a transfer ply 10. The injection-molded article 34 is preferably produced by means of an IMD method. For this, the transfer film 10 is arranged in an injection mold. The transfer film 10 is then back injection molded with a plastic injection-molding composition 36. In a further step, the carrier film 12 together with the master structure is removed from the transfer ply 14 of the transfer film 10. As a result, the top coat 16 together with the further layers remains on the plastic injection-molding composition 36 and together with same forms the injection-molded article 34. The top coat 16 represents the outer layer of the injection-molded article 34. As a result, the injection-molded article 34 has a soft-touch effect.

### LIST OF REFERENCE NUMBERS

10 transfer film
12 carrier film
14 transfer ply
16 top coat
18 structured varnish
20 carrier layer
22 detachment layer
24 intermediary layer/adhesion promoter
26 decorative layer
28 metallization
30 adhesive layer/primer layer
32 haptic varnish
34 injection-molded article
36 plastic injection-molding composition
38 glossy area
40 matte area

1. A transfer film which comprises a carrier film and a transfer ply with a top coat arranged on the carrier film and detachable from the carrier film, wherein
a master structure is molded on the carrier film on its side facing the transfer ply, and the top coat comprises a structuring which has a structure complementary to the master structure.

2. The transfer film according to claim 1, wherein
a structured varnish comprises the master structure.

3. The transfer film according to claim 2, wherein
the carrier film consists of a self-supporting structured varnish.

4. The transfer film according to claim 2, wherein
the carrier film comprises a carrier layer and structured varnish arranged on
the carrier layer in the direction of the transfer ply.

5. The transfer film according to claim 1, wherein
the master structure or the structured varnish and/or the top coat have a homogeneous surface structure at least in areas.

6. The transfer film according to claim 1, wherein
the master structure or the structured varnish has a structural depth of from 1 μm to 10 μm.

7. The transfer film according to claim 1, wherein
the master structure or the structured varnish has a chemically inert surface.

8. The transfer film according to claim 1, wherein
the structured varnish comprises at least one UV-curable and/or at least one isocyanate component and/or at least one melamine component.

9. The transfer film according to claim 1, wherein
the top coat is formed from long-chain polymers.

10. The transfer film according to claim 1, wherein
the top coat is formed from polyurethane, with a molecular weight between 2000 and 8000.

11. The transfer film according to claim 10, wherein
the polyurethanes are formulated into a soft-touch varnish via a cobinder or with an isocyanate binder.

12. The transfer film according to claim 9, wherein
the polymers are formed cross-linked.

13. The transfer film according to claim 1, wherein
the top coat comprises fillers, made of PMMA, silicones, polyurethanes, different copolymers and/or mineral compounds.

14. The transfer film according to
the top coat comprises silicone-containing acrylates, silicone-containing polyurethanes, oils, waxes and/or wax dispersions.

15. The transfer film according to claim 1, wherein
the top coat comprises silicones.

16. The transfer film according to claim 1, wherein
the top coat comprises UV-curable components.

17. The transfer film according to claim 1, wherein
the top coat has a gloss level of between 20 and 60.

18. The transfer film according to claim 1, wherein
the top coat comprises matting agents.

19. The transfer film according to claim 1, wherein
the top coat has an elongation of at least 50%.

20. The transfer film according to claim 1, wherein
the top coat has a temperature resistance of up to 200° C.

21. The transfer film according to claim 1, wherein
the top coat is formed such that it has a soft-touch effect.

22. The transfer film according to claim 1, wherein
the top coat has a pencil hardness HB.

23. The transfer film according to claim 1, wherein
a detachment layer is arranged between the top coat and the master structure or the structured varnish.

24. The transfer according to claim 1, wherein
an intermediary layer is arranged on the side of the top coat facing away from the carrier film.

25. The transfer film according to claim 24, wherein
the intermediary layer comprises cross-linkable acrylates.

26. The transfer film according to claim 24, wherein
the intermediary layer has a layer thickness between 0.1 μm and 10 μm.

27. The transfer film according to claim 1, wherein
the transfer film comprises a decorative layer, a metallization and/or an adhesive layer or a primer layer.

28. The transfer film according to claim 1, wherein
a haptic varnish is arranged at least in areas on the side of the carrier layer facing away from the top coat or on the side of the structured varnish facing away from the top coat.

29. A method for producing a transfer film for use as IMD soft-touch film, which comprises a carrier film and a transfer ply with a top coat arranged on the carrier film and detachable from the carrier film, wherein
a master structure, is incorporated or produced in the carrier film, and the top coat is applied to the master structure, wherein a structure complementary to the master structure of the carrier film is molded into the top coat.

30. The method according to claim 29, wherein
the master structure is produced by applying a structured varnish to a carrier layer.

31. The method according to claim 30, wherein
the structured varnish is printed.

32. The method according to claim 30, wherein
the structured varnish is applied over the whole surface of the carrier layer.

33. The method according to claim 30, wherein
the structured varnish is applied partially to the carrier layer.

34. The method according to claim 33, wherein
a further varnish is applied at least in areas to the carrier layer in areas where no structured varnish is arranged.

35. The method according to claim 29, wherein
the carrier layer is pre-treated to improve the adhesion between carrier layer and structured varnish.

36. The method according to claim 29, wherein
the top coat is cured by means of UV curing or thermally during the production of the transfer film.

37. The method according to claim 29, wherein
an intermediary layer or adhesion promoter, a decorative layer and/or an adhesive layer are applied, on the top coat.

38. The method according to claim 29, wherein
a metallization is applied, by means of vapor deposition.

39. The method according to
a haptic varnish is applied at least in areas on the side of the carrier layer facing away from the top coat or on the side of the structured varnish facing away from the top coat.

40. (canceled)

41. (canceled)

42. A method for producing an injection-molded article decorated with a transfer ply of a transfer film with the following steps:
arranging a transfer film according to claim 1 in an injection mold,
back injection molding the transfer film with a plastic injection-molding composition,
removing the carrier film together with the master structure from the transfer ply of the transfer film.

43. The method according to claim 42, wherein
the top coat is cured during the production of the transfer film by means of UV curing and/or thermally.

44. The method according to
the curing of the top coat as post-cure film is carried out.
